(19) United States
(12) Patent Application Publication
(10) Pub. No.: US 2016/0349940 A1
(43) Pub. Date: Dec. 1, 2016

(54) MENU ITEM SELECTION ON A HANDHELD DEVICE DISPLAY

(71) Applicant: SYMBOL TECHNOLOGIES, LLC, Lincolnshire, IL (US)

(72) Inventors: PRASHANTH V. KADUR, Holbrook, NY (US); JAMES FAGIOLI, HOLTSVILLE, NY (US)

(21) Appl. No.: 14/721,029

(22) Filed: May 26, 2015

(51) Int. Cl. G06F 3/0482; G06F 1/16; G06F 3/01; G06F 3/0481; G06F 3/0484; G06F 3/0346

(52) U.S. Cl. CPC G06F 3/0482; G06F 3/04842; G06F 3/0346; G06F 3/017; G06F 3/04812; G06F 1/1694

(57) ABSTRACT

Apparatus and method for menu item selection on a handheld device display. The method includes a first step of moving the device using a first gesture to invoke a menu mode on the display, where the menu mode shows selectable menu items and a graphic pointer for selecting menu items. A next step includes moving the device using a second gesture to move the graphic pointer over a selected menu item. A next step includes waiting a predetermined amount of time to confirm the selected menu item. A next step includes performing a preprogrammed function associated with the selected menu item.

### BACKGROUND

With the advent of large display user interfaces on handheld communication devices, a typical user can easily select menu items from the user interface by pressing a displayed icon on a touch screen display using one of their fingers. However, in some environments a user may not have a finger free to select a menu item on their handheld device. Some examples of this include a user wearing gloves, such as a worker in an industrial environment, a firefighter, or even someone outside in the winter. Another example is someone who is carrying items such that they only have one hand available to operate their device. In these cases, the user will have difficulty navigating the touch screen user interface of the handheld or mobile device.

Hence, there is a need for a technique to alleviate the above issues in menu item selection on a handheld device display.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a handheld device, in accordance with some embodiments of the present invention.

FIG. 2 is a perspective view of an operational step in accordance with some embodiments of the present invention.

FIG. 3 is a perspective view of another operational step in accordance with some embodiments of the present invention.

FIG. 4 is a perspective view of yet another operational step in accordance with some embodiments of the present invention.

FIG. 5 is a flow diagram of a method, in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present invention provides a technique for menu item selection on a handheld device display without having to touch the screen at all. In particular, the present invention utilizes three-dimensional manipulation of the handheld device to allow a user to select menu functions using one handed operation without the need to use a finger, stylus, or other hand to directly select the item.

Those skilled in the art will recognize that the figures do not depict all of the equipment necessary within a handheld electronic device for the device to operate but only those system components and logical entities particularly relevant to the description of embodiments herein. Each device shown in the figures is known to also comprise basic interconnected components such as, but not limited to, radios, antennas, keypads, speakers, microphones, memories, interfaces and processors, such as microprocessors, microcontrollers, digital signal processors, application-specific integrated circuits, field programmable gate arrays, and/or logic circuitry. Such components are typically adapted to implement algorithms and/or protocols that are expressed using high-level design languages or descriptions, computer instructions, and messaging logic flow diagrams. Thus, given an algorithm, a logic flow, a messaging/signaling flow, and/or a protocol specification, those skilled in the art are aware of the many design and development techniques available to implement a processor that performs the given logic.

Therefore, each mobile device represents a known apparatus that has been adapted, in accordance with the description herein, to implement various embodiments of the present invention. Furthermore, those skilled in the art will recognize that aspects of the present invention may be implemented in and across various physical components and none are necessarily limited to single platform implementations. It is within the contemplation of the invention that the operating requirements of the present invention can be implemented in firmware or hardware, with the function being implemented in a software processor (or a digital signal processor) being merely a preferred option in conjunction with the firmware or hardware.

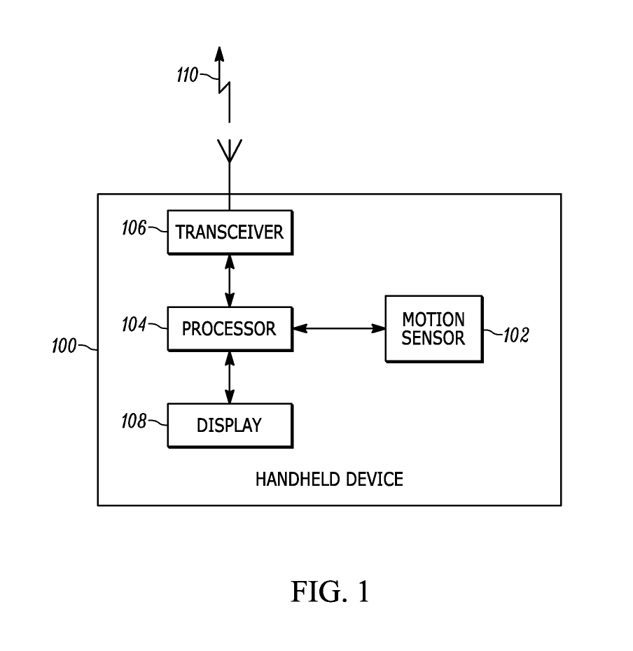

FIG. 1 represents an embodiment of a basic handheld electronic device 100, such as a smart phone, mobile computer, mobile communication device, computer, tablet, personal digital assistant, scanner, card reader, Radio Frequency Identification (RFID) tag reader, etc. The device 100 is operable to provide some type of information signaling or communication action 110. For example, a smart phone can communicate with a local area or wide area network, an RFID tag reader can emit a signal 110 and receive a response from a nearby RFID tag, and a scanner can send a laser signal 110 to a nearby barcode and read a reflected signal.

Typically, the device 100 can include a processor 104 coupled to a display 108 such as a touch screen display, and a motion sensor 102 such as an accelerometer, magnetometer, gyroscope, and the like. The device can also include some type of transceiver 106 which can be a conventional wireless transceiver, a scanner, an RFID reader, etc. The present invention provides a technique for a user to select menu items on a display of the device without touching the display.

In practice, the present invention will invoke a menu display by a three-dimensional manipulation event such as a shake of the device or press of a button. As a result of this event, a menu can be shown on the display including visual menu icons on the display, e.g. targets at each corner of the display, plus a moveable graphic pointer, such as a cursor or puck (as shown), in a center of the display. The user tilts the device so that the graphic pointer or cursor slides across the screen into one of the corners over one of the menu items. When the graphic pointer or cursor comes to rest, a function of that menu item is invoked. Each of the four corners can represent a preprogrammed function to invoke. Optionally, a display is not needed for the device at all since menu selection is performed completely by gestures. As long as the user knows where each particular menu item is located in a virtual three-dimensional space of gestures, a menu item can be selected without having any device display or touch screen.

Preferably, the present invention provides a handheld device with menu item selection on a display of the handheld device, in accordance with some embodiments. The handheld device 100 includes a motion sensor 102 operable to detect gestures by a user that moves the device in three-dimensions. Preferably, the motion sensor is an accelerometer, but it can consist of any motion sensing device. The handheld device 100 also includes a display 108 operable to display selectable menu items and a graphic pointer. It should be noted that the graphic pointer could be of any design. The handheld device 100 further includes a processor 104 coupled to the motion sensor and the display, the processor operable to discern gestures made by the user, wherein a first gesture invokes a menu mode on the display that shows selectable menu items and a graphic pointer for selecting menu items, and a second gesture moves the graphic pointer over a selected menu item, whereupon the processor waits a predetermined amount of time to confirm the selected menu item, and whereupon the processor performs a preprogrammed function associated with the selected menu item. Different first gestures could be used to invoke different menus. A third gesture could be used to cancel the menu or perform other functions.

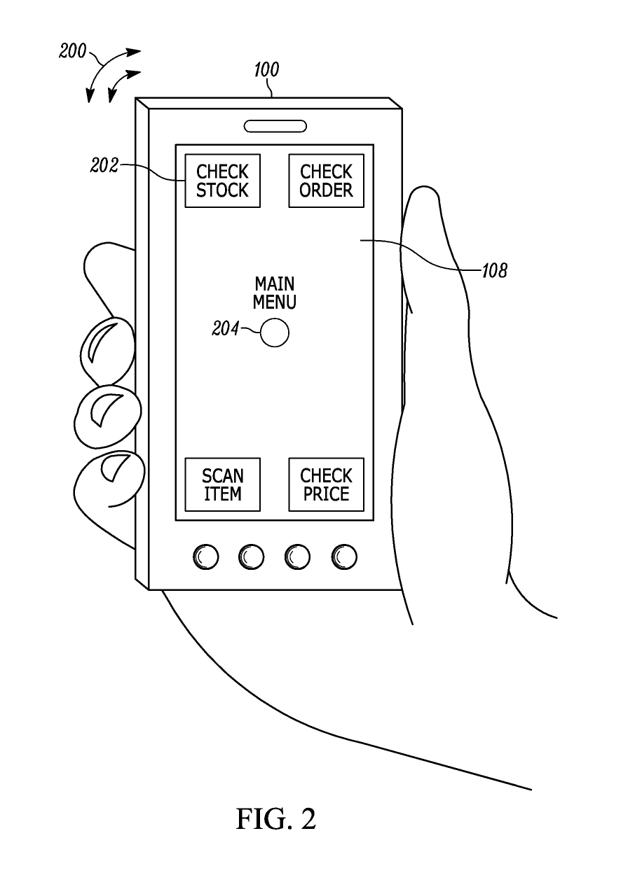

Referring to FIG. 2, the first gesture 200 can move the device in a back-and-forth shaking of the device in a predetermined manner, for example. However, any predefined gesture could be used. In this example, the predetermined manner can be a shaking of at least a minimum magnitude, distance, frequency, or time. The motion sensor provides signals indicative of the particular gesture to the processor which interprets the signals into a specific gesture. When the first gesture meets the requirements of the predetermined manner, the processor will call up a menu mode display from memory (as shown). The menu items 202 shown in menu mode can be of any number and can be located anywhere on the display. In this example, four menu items 202 are shown, one at each corner of the display 108. The four menu items shown in this example are CHECK STOCK, CHECK ORDER, SCAN ITEM, and CHECK PRICE. However, it should be recognized that any menu items can be specified as suited to the particular task presented. In menu mode the processor also directs the display to display the graphic pointer 204 in a central region or exact center of the display 108.

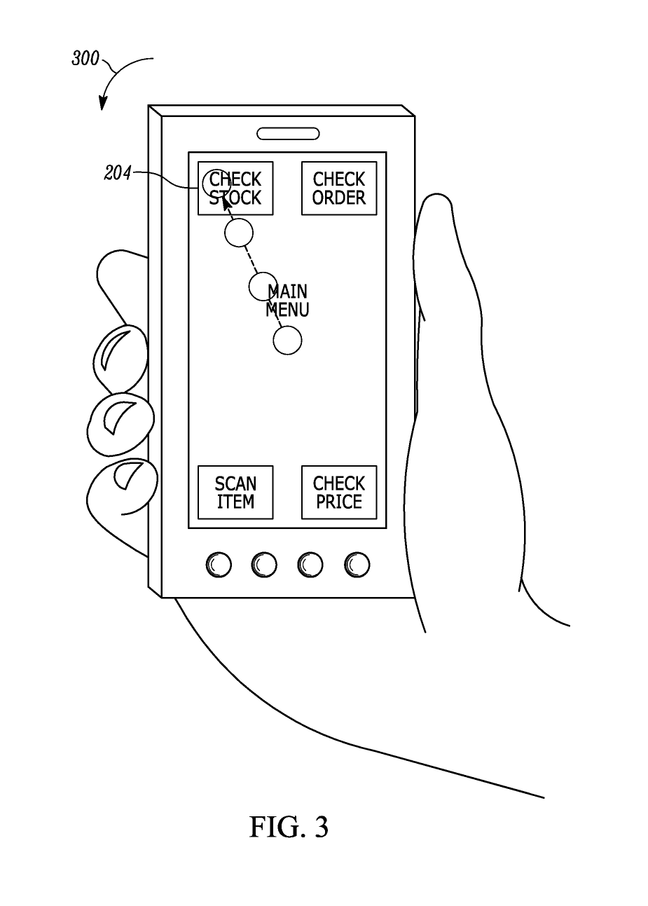

Referring to FIG. 3, after the menu mode with selectable menu items and graphic pointer are displayed, the processor then waits for a specific second gesture from the user. For example, the second gesture 300 can tilt the device in a predetermined manner. However, any predefined second gesture could be used. In this example, the second gesture 300 tilts the device down and to the left. The motion sensor provides signals indicative of the particular second gesture to the processor which interprets the signals into a specific second gesture. When the second gesture is a tilting of the device, wherein the processor emulates movement of the graphic pointer 204 on the display in a direction of the tilt (as shown). The processor waits a predetermined amount of time to confirm the selected menu item (e.g. CHECK STOCK), whereupon the processor performs a preprogrammed function associated with the selected menu item (e.g. checking stock of an item scanned by the device). The predetermined time is a time needed for the graphic pointer to come to rest over a selected menu item, such as coming to rest at a corner of the display over a selected menu item. This time could be extended to allow the user to change their mind and move the graphic pointer to a different menu item. Once the time has expired, the processor performs an action relating to the selected menu item, e.g. direct the transceiver to perform a communication external to the device relating to the selected menu item such as sending out a scanning signal to read an item and then check the stock of that item, or scanning an item and storing its information locally on the device or looking it up in a database stored locally on the device.

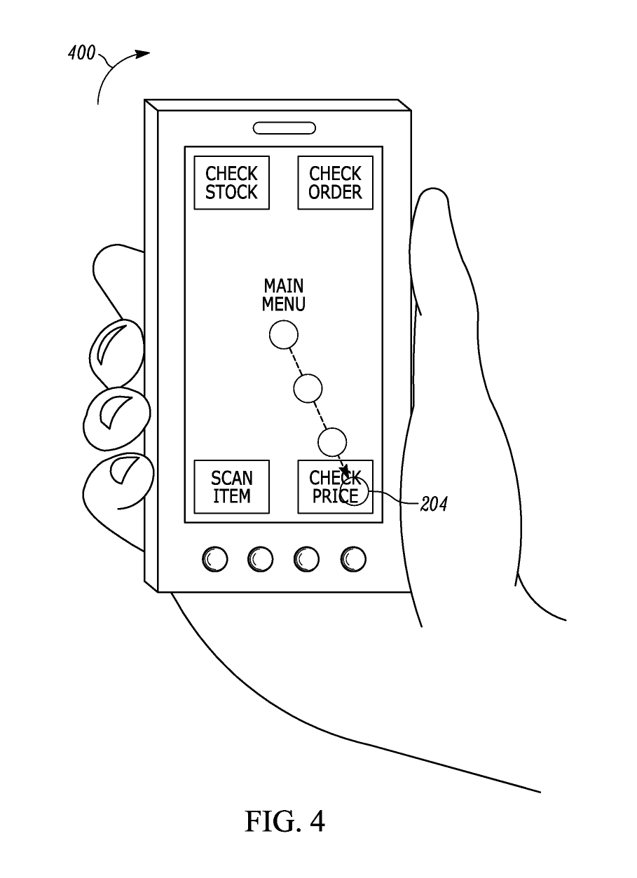

Alternatively, and referring to FIG. 4, after the menu mode with selectable menu items and graphic pointer are displayed (from FIG. 2), the processor then waits for a specific second gesture from the user. For example, the second gesture 400 can tilt the device in a predetermined manner. However, any predefined second gesture could be used. In this example, the second gesture 400 tilts the device up and to the right. The motion sensor provides signals indicative of the particular second gesture to the processor which interprets the signals into a specific second gesture. When the second gesture is a tilting of the device, wherein the processor emulates movement of the graphic pointer 204 on the display in a direction of the tilt (as shown). The processor waits a predetermined amount of time to confirm the selected menu item (e.g. CHECK PRICE), whereupon the processor performs a preprogrammed function associated with the selected menu item (e.g. checking a price of an item scanned by the device). The predetermined time is a time needed for the graphic pointer to come to rest over a selected menu item, such as coming to rest at a corner of the display over a selected menu item. This time could be extended to allow the user to change their mind and move the graphic pointer to a different menu item. Once the time has expired, the processor performs an action relating to the selected menu item, e.g. send out a scanning signal to read an item and then check the price of that item.

It should be noted that the tilting of the device need not be performed from a perfectly horizontal position. For example, when the menu is invoked after the first gesture, whatever position the device is oriented in is used as a baseline orientation, and any tilting of the device performed afterwards will be able to move the graphic pointer in the direction of tilt.

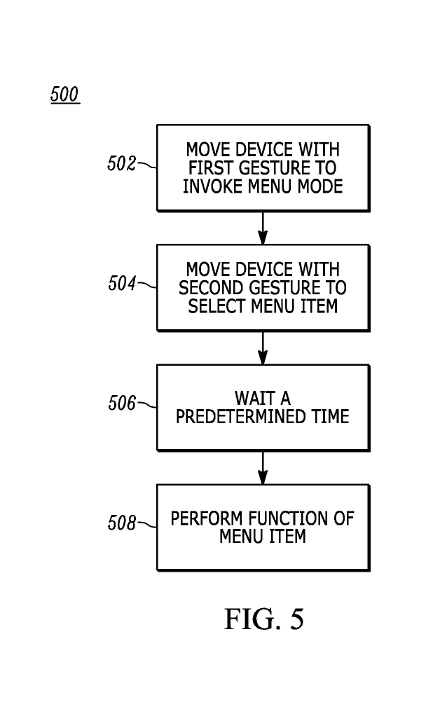

FIG. 5 presents a flow chart that illustrates a method 500 for menu item selection on a display of a handheld device, according to an exemplary embodiment of the present invention.

A first step 502 includes moving the device using a first gesture to invoke a menu mode on the display, the menu mode showing selectable menu items and a graphic pointer for selecting menu items. The first gesture can be a press of a button or a shaking of the device in a predetermined manner. The menu mode can display the graphic pointer in a central region or an exact center of the display. The menu mode also displays at least one menu item in at least one corner of the display or along at least one edge of the display.

A next step 504 includes moving the device using a second gesture to move the graphic pointer over a selected menu item. The second gesture can be a tilting of the device, wherein the device emulates movement of the graphic pointer in a direction of the tilt in order to move the graphic pointer over a menu item.

A next step 506 includes waiting a predetermined amount of time or for a predetermined event to confirm the selected menu item. The predetermined time or event is the time needed for the graphic pointer to come to rest over a selected menu item, such as at a corner of the display or along an edge of the display. This time can be extended to allow the user to change their mind and move the graphic pointer again.

A next step 508 includes performing a preprogrammed function associated with the selected menu item, such as a communication action external to the device.

Advantageously, the solution described herein allows a gloved operator to easily invoke functions or applications on a handheld device. The present invention also allows one handed operation. The present invention also allows invoking functions on a device without touching the screen or a button. The present invention also allows a user to invoke functions without even looking at the display of a device. In addition, the present invention could easily be used in any handheld or wearable device that contains an accelerometer and a display, such as a consumer smartphone or tablet.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for menu item selection on a handheld device, the method comprising:
moving the device using a first gesture to invoke a menu mode, the menu mode providing selectable menu items and a pointer for selecting menu items;
moving the device using a second gesture to move the pointer over a selected menu item; and
performing a preprogrammed function associated with the selected menu item.

2. The method of claim 1, wherein before the performing step further comprising a step of waiting a predetermined amount of time to confirm the selected menu item.

3. The method of claim 1, wherein the first gesture is shaking the device in a predetermined manner.

4. The method of claim 1, wherein the selectable menu items and a graphic pointer appear on a display of the device in the menu mode.

5. The method of claim 4, wherein the menu mode displays the graphic pointer in a central region of the display.

6. The method of claim 4, wherein the menu mode displays at least one menu item in at least one corner of the display.

7. The method of claim 6, wherein before the performing step further comprising a step of waiting a predetermined amount of time to confirm the selected menu item, wherein the predetermined time is a time needed for the graphic pointer to come to rest at a corner of the display over a selected menu item.

8. The method of claim 4, wherein the second gesture is a tilting of the device, wherein the device emulates movement of the graphic pointer in a direction of the tilt.

9. The method of claim 8, wherein before the performing step further comprising a step of waiting a predetermined amount of time to confirm the selected menu item, wherein the predetermined time is a time needed for the graphic pointer to come to rest over a selected menu item.

10. The method of claim 1, wherein the function invokes an action related to the selected menu item.

11. A method for menu item selection on a display of a handheld device, the method comprising:
moving the device using a first gesture to invoke a menu mode on the display, the menu mode showing at least one selectable menu item in at least one corner of the display and a graphic pointer for selecting menu items;
moving the device using a tilting gesture, wherein the device emulates movement of the graphic pointer in a direction of the tilt to move the graphic pointer over a selected menu item;
waiting until the graphic pointer comes to rest at a corner of the display over a selected menu item to confirm the selected menu item; and
performing an action associated with the selected menu item.

12. A handheld device with menu item selection on a display of the handheld device, comprising:
a motion sensor operable to detect gestures by a user moving the device;
a display operable to display selectable menu items and a graphic pointer; and
a processor coupled to the motion sensor and the display, the processor operable to discern gestures, wherein a first gesture invokes a menu mode on the display that shows selectable menu items and a graphic pointer for selecting menu items, and a second gesture moves the graphic pointer over a selected menu item, whereupon the processor waits a predetermined amount of time to confirm the selected menu item, and whereafter the processor performs a preprogrammed function associated with the selected menu item.

13. The device of claim 12, wherein the motion sensor is an accelerometer.

14. The device of claim 12, wherein the first gesture is shaking the device in a predetermined manner.

15. The device of claim 12, wherein in the menu mode the processor directs the display to display the graphic pointer in a central region of the display.

16. The device of claim 12, wherein in the menu mode the processor directs the display to display at least one menu item in at least one corner of the display.

17. The device of claim 16, wherein the predetermined time is a time needed for the graphic pointer to come to rest at a corner of the display over a selected menu item.

18. The device of claim 12, wherein the second gesture is a tilting of the device, wherein the processor emulates movement of the graphic pointer on the display in a direction of the tilt.

19. The device of claim 18, wherein the predetermined time is a time needed for the graphic pointer to come to rest over a selected menu item.

20. The device of claim 12, further comprising a transceiver, wherein the processor is operable to direct the transceiver to perform an action related to the selected menu item.
